(19) United States
(12) Patent Application Publication
(10) Pub. No.: US 2013/0212886 A1
(43) Pub. Date: Aug. 22, 2013

(54) Lock Optional, Spring Assisted Folding Knife

(71) Applicants: Grant Woodrow Hawk, Idaho City, ID (US); Gavin Dan Hawk, Idaho City, ID (US)

(72) Inventors: Grant Woodrow Hawk, Idaho City, ID (US); Gavin Dan Hawk, Idaho City, ID (US)

(21) Appl. No.: 13/674,846

(22) Filed: Nov. 12, 2012

Related U.S. Application Data
(60) Provisional application No. 61/629,230, filed on Nov. 14, 2011.

(51) Int. Cl. B26B 1/04; B26B 1/02

(52) U.S. Cl. CPC B26B 1/04; B26B 1/02
USPC 30/161; 30/155

(57) ABSTRACT

A folding knife, whereby a unique arrangement of linked levers, produces a geometry of mechanical advantage, allowing the user to safely deploy an extended, but unlocked blade, by simply griping the handle. A resilient element, in conjunction with the linked levers, produces a powered assist in the act of opening the blade and also in the act of closing the blade. Alternately, further means are disclosed of providing the option of a positive locking blade.

### BACKGROUND

Historically, folding knives have fallen into two distinct categories, generally referred to as friction folders of the first category, or locking folders of the second category. Friction folders are typically configured in such a way as to provide a detent in both the open and closed position. The act of opening or closing such a knife often requires the user to deploy both hands in order to overcome a detent of varying degrees of resistance, while locking folders typically lock automatically upon opening. The two main options have been, that of either designing a knife more prone to the dangers of accidental closing, or that of designing a knife that requires delocking before closing, but somewhat less likely to close unintentionally. The compromise inherent in friction folding knife design, led to the development of locking folders that must be manually delocked before closing. These locking folding knives solved most of the safety considerations but introduced further complications of mechanical complexity, and in many cases, new safety considerations arising from the act of delocking, as in the case of the so called liner-locks which require the thumb to cross the path of the closing blade. The inconvenience introduced by the necessity to delock is often seen as a further disadvantage of current locking designs.

### OBJECTIVE

The objective therefore, of the current invention is to provide for a folding knife, of a non-locking design, that overcomes the safety disadvantages of the prior art. Further advantages include ease of manufacture, by virtue of fewer and simpler parts, and a unique mechanism that allows quick and easy manipulation through both the opening and closing cycles.

Reference Numbers

| | | | |
|---|---|---|---|
| 10 | Blade | 12 | Handle Frame |
| 14 | Resilient Member | 16 | Blade Pivot Pin |
| 18 | Stop Pin | 20 | Flipper Spur |
| 22 | Handle Overlay | 24 | Traveling Link |
| 26 | Traveling Link Pivot | 28 | Frame Spacer |
| 30 | Traveling Link Detent Open | 32 | Traveling Link Detent Closed |
| 34 | Detent Roller | 36 | Detent Roller Axis Pin |
| 38 | Detent Roller Pocket | 40 | Resilient Member Fixed Anchor |
| 42 | Resilient Member Traveling | 44 | Frame Spacer Screws |
| | Anchor | | |

### DRAWING FIGURES

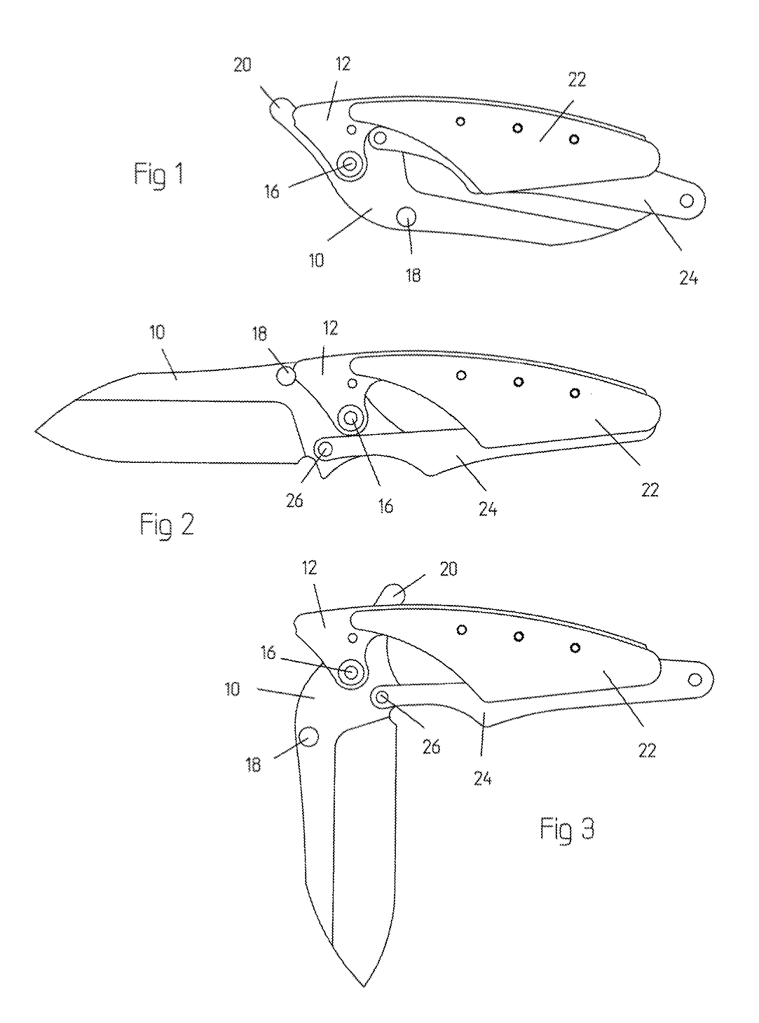

Drawing Sheet 1/3 shows the knife in the three stages of opening and closing, FIG. 1 shows the knife in closed position, FIG. 2 shows the same knife in the open position and FIG. 3 shows the knife at the half open position.

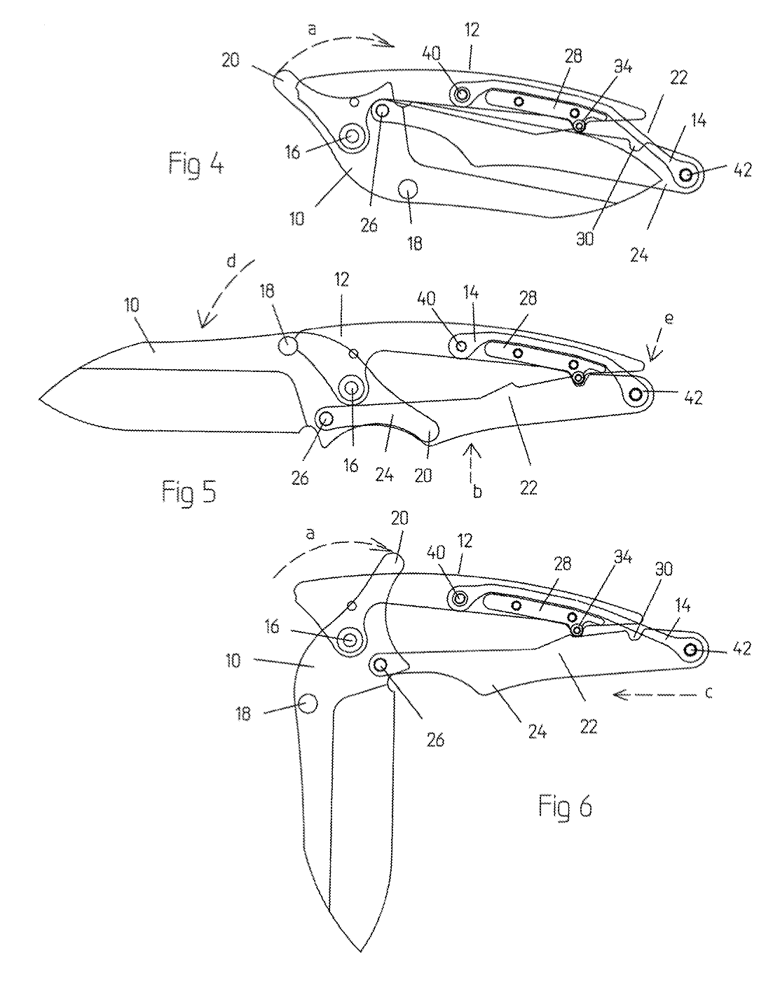

Drawing Sheet 2/3 shows the knife in the three stages of opening and closing with all the parts shown in transparent view to illustrate their interaction. FIG. 4 shows the knife in closed position, FIG. 5 shows the knife in open position, and FIG. 6 shows the knife in mid travel between open and closed.

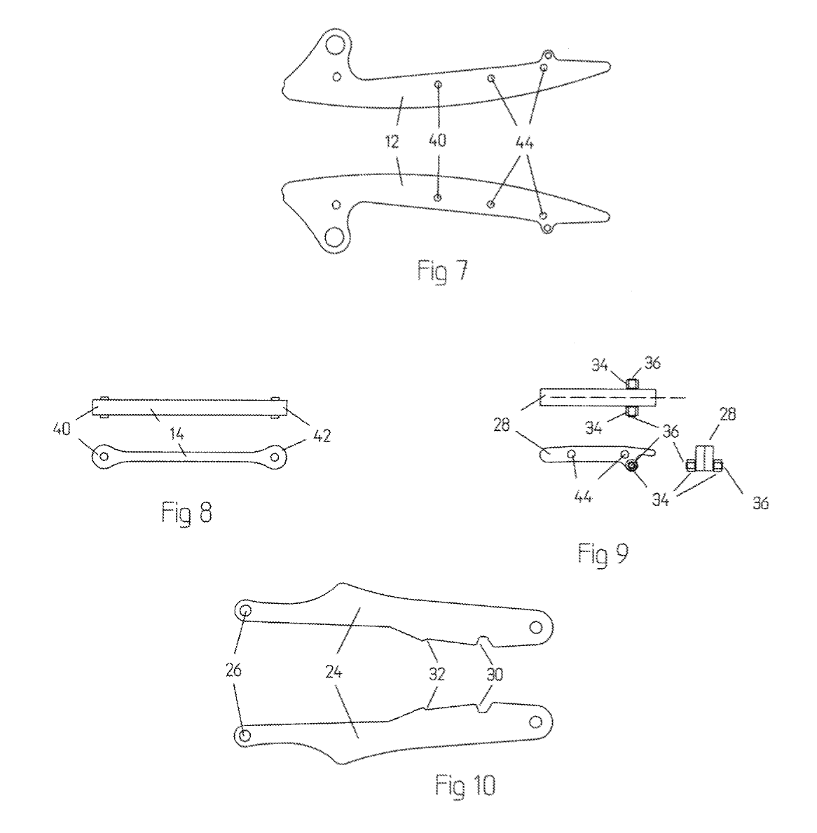

Drawing Sheet 3/3, FIG. 7 shows a side view of handle frames front and back. FIG. 8 shows top and side view of resilient member, FIG. 9 shows top, side, and end view of frame spacer with rollers and pins, FIG. 10 shows a side view of traveling links and the portion of traveling links that serves as an open detent and closed detent.

### IN OPERATION

Referring to FIG. 4 of sheet 2/3 the opening cycle is initiated by pressing on trigger spur 20, in the direction of arrow a. As Trigger spur 20 is made to rotate about blade pivot pin 16, traveling link 24 is forced rearward, extending resilient member 14, until reaching a point slightly past equilibrium, as shown in FIG. 6. At this point in the travel of blade 10 towards open, the resilient member 14, powers traveling link 24 in the direction of arrow c, causing blade 10 to complete it's travel to full open position as in FIG. 5.

When the blade is in the full open position of FIG. 5, the blade is not locked, but the mere act of gripping the handle, which applies pressure in the direction of arrow b is sufficient to safely hold the blade in position for most practical purposes, by virtue of the engagement of detent roller 34 with traveling link detent 30.

Closing of blade 10 is accomplished by simply exerting pressure on blade 10 in the direction of arrow d while holding handle frame 12 stationary. As blade 10 moves toward closing, the detent notch 30 of FIG. 11, sheet 3/3, is forced out of engagement with detent roller 36, as shown at FIG. 10. Allowing the blade 10 to return to the closed position.

In order to reconfigure the non locking design (as shown) to that of a locking design (not shown), it is only necessary to alter the angle of the interface of detent 30 to prevent the escape of traveling link 24 from roller 36. When the design is a lock open configuration, the delocking cycle must be preceded by finger pressure applied to traveling link 24 at a point, and in a direction, as indicated by arrow e of FIG. 5.

### IN CONCLUSION

As can be readily understood by a careful analysis of the foregoing the “lock optional, spring assist, folding knife” of the current invention offers substantial improvements for a folding knife. For example, even though the handle to blade interface may be non-locking, the configuration is such that the mere act of griping the handle insures that the blade will not accidentally close, resulting in injury to the operator. Furthermore it is clearly apparent that the greatly simplified means of providing for a spring assisted opening blade and the strong and easily manufactured parts, by which that objective is achieved, holds great advantage over that of the prior art.

What is claimed is:

1. A knife comprising:
a blade;
a handle element having a first end and a second end; the first end of the handle element being pivotably coupled to the blade at a first fixed pivot axis to permit the blade to rotate between a closed position and an open position;
a traveling link having a first end and a second end, the first end of the traveling link being pivotably coupled to the blade at a second fixed pivot axis; and
a resilient member being connected to the second end of the traveling link and being connected to a portion of the handle element, wherein the resilient member limits the movement of the traveling link along a predetermined path between a first position when the blade is in a open position and a second position when the blade is in a closed position.

2. The knife of claim 1, the traveling link further comprising a first detent and a second detent and the handle further comprising a protrusion, wherein the protrusion engages the first detent when the blade is in the open position selectively locking the blade in the open position and the protrusion engages the second detent when the blade is in the closed position.

3. The knife of claim 2, wherein in the open position the traveling link is exposed to provide a gripping surface for a user.

4. The knife of claim 3, wherein the protrusion is a free turning roller.

5. The knife of claim 4, the blade further comprising a cutting surface at a first end and a protrusion at a second end, wherein the protrusion extends beyond the handle element when the blade is in the closed position.

6. A knife comprising:
a blade, the blade having a first planar surface and a second planar surface;
a handle element having a first end and a second end; the first end of the handle element being pivotably coupled to the blade at a first fixed pivot axis to permit the blade to rotate between a closed position and an open position;
a first traveling link having a first end and a second end, the first end of the first traveling link being pivotably coupled to the first planar surface of the blade at a second fixed pivot axis;
a second traveling link having a first end and a second end, the first end of the second traveling link being pivotably coupled to the second planar surface of the blade at the second fixed pivot axis; and
a resilient member having a first end and a second end, the first end of the resilient member being connected to both the second end of the first traveling link and the second end of the second traveling link, the second end of the resilient member being connected to a portion of the handle element, wherein the resilient member limits the movement of the first and second traveling links along a predetermined path between a first position when the blade is in a open position and a second position when the blade is in a closed position.
